(19) United States
(12) Patent Application Publication
(10) Pub. No.: US 2010/0124699 A1
(43) Pub. Date: May 20, 2010

(54) BATTERY COVER LATCHING MECHANISM

(75) Inventors: LEE-HAN NG, Shenzhen City (CN); LUCAS HUANG, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignee: FIH (HONG KONG) LIMITED, Kowloon (HK)

(21) Appl. No.: 12/548,022

(22) Filed: Aug. 26, 2009

(30) Foreign Application Priority Data
Nov. 17, 2008 (CN) 200810305597.5

(51) Int. Cl. H01M 2/10

(52) U.S. Cl. 429/100

(57) ABSTRACT

A battery cover latching mechanism is provided. The battery cover latching mechanism includes a body member defining a battery receiving space, a battery cover, and the button member. The battery cover is placed above the body member to cover the battery receiving space. The battery cover defines a latching slot. The button member includes a latching block and a resisting block. The latching block latches in the latching slot. The resisting block is configured for resisting the battery cover away from the body member.

### BACKGROUND

1. Technical Field

The present disclosure relates to battery cover latching mechanisms and, particularly, to a battery cover latching mechanism used in a portable electronic device.

2. Description of Related Art

Battery cover latching assemblies are usually provided to secure battery within portable electronic devices.

A typical battery cover latching assembly for an electronic device usually includes a battery cover and latching means, e.g., a locking pin latching into a locking hole. The battery cover can be detachably mounted to a housing of portable electronic devices using the latching means.

However, removal of the battery cover may require a strong force, which may damage the locking pin.

Therefore, there is room for improvement within the art.

### BRIEF DESCRIPTION OF THE DRAWINGS

Many aspects of the battery cover latching mechanism can be better understood with reference to the following drawings. These drawings are not necessarily drawn to scale, the emphasis instead being placed upon clearly illustrating the principles of the present battery cover latching mechanism. Moreover, in the drawings like reference numerals designate corresponding sections throughout the several views.

FIG. 1 is an exploded, isometric view of a battery cover latching mechanism, in accordance with an exemplary embodiment.

FIG. 2 is similar to FIG. 1, but without the battery cover.

FIG. 3 is an isometric view of the button member shown in FIG. 1.

FIG. 4 is a partially, isometric view of the battery cover shown in FIG. 1.

FIG. 5 is an assembled view of the battery cover latching mechanism shown in FIG. 1.

FIG. 6 is a cross-sectional view of the battery cover latching mechanism shown in FIG. 5 taken along line VI-VI.

FIG. 7 is a schematic view showing a working status of the battery cover latching mechanism shown in FIG. 6.

### DETAILED DESCRIPTION

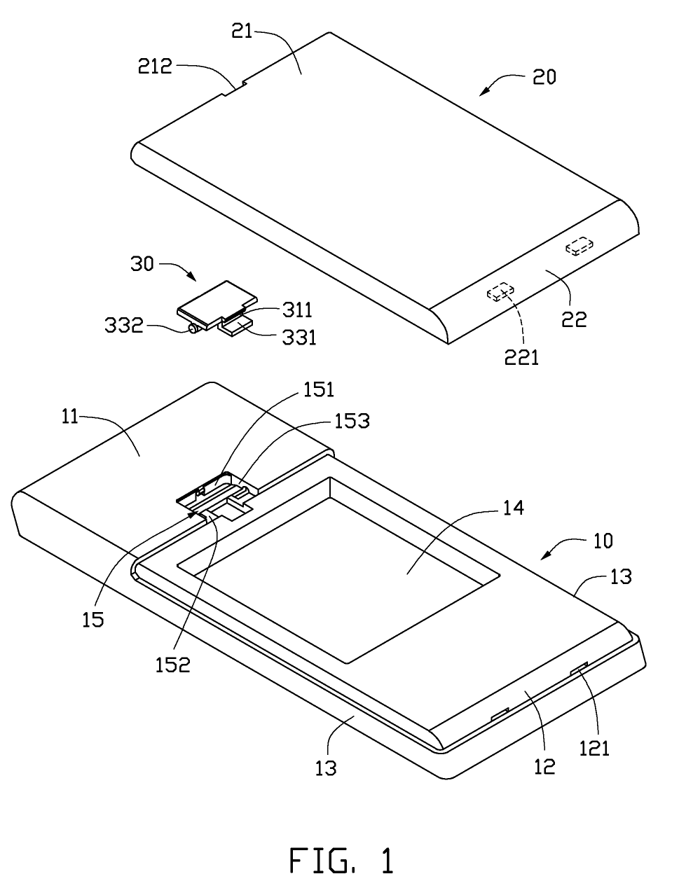

FIG. 1 shows an exemplary battery cover latching mechanism 100 including a body member 10, a battery cover 20, and a button member 30. The battery cover 20 is placed above the body member 10. The button member 30 is pivotably mounted to the body member 10, and used to releasably lock the battery cover 20 to the body member 10.

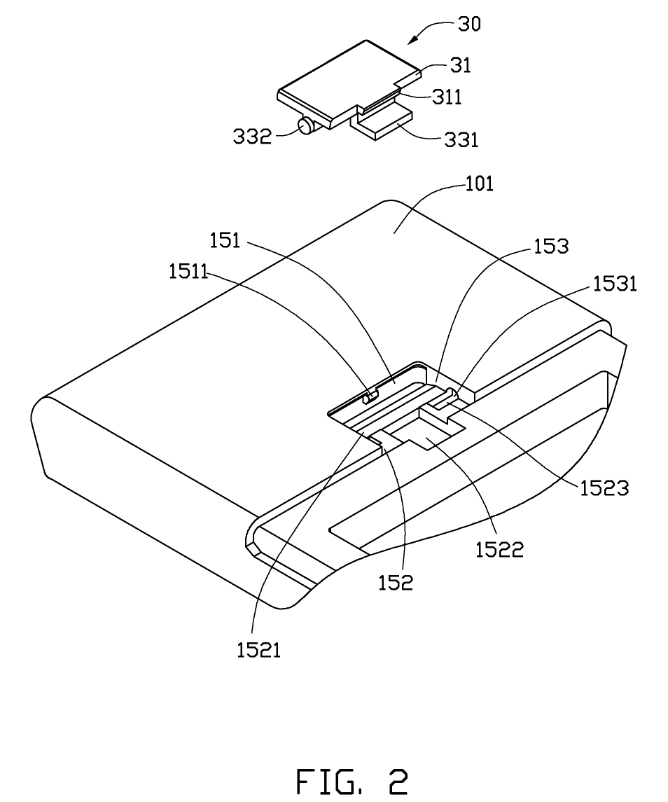

Referring to FIGS. 1 and 2 together, the body member 10 can be a housing of a portable electronic device. The body member 10 includes a top wall 11, a bottom wall 12 opposite to the top wall 11, and two opposite sidewalls 13. The two sidewalls 13 connect the top wall 11 and the bottom wall 12 to enclose a battery receiving space 14. The top wall 11 defines a cavity 15 adjacent to the battery receiving space 14. The cavity 15 includes a first wall 151 facing the battery receiving space 14, a second wall 152, and two third walls 153. The second wall 152 and the two third walls 153 connect the first wall 151 and the battery receiving space 14. The first wall 151 includes a protrusion 1511, used to resist the battery cover 20. The second wall 152 includes a resisting block 1521 adjacent to the first wall 151. The resisting block 1521 is used to abut against the button member 30. The second wall 152 further includes a cutout 1522 and two pivot slots 1523. The cutout 1522 is defined adjacent to the battery receiving space 14. The two pivot slots 1523 are symmetrically defined on both sides of the cutout 1522. Each of the two third walls 153 defines a pivot hole 1531 corresponding to one pivot slot 1523. The pivot slots 1523 communicate with the pivot holes 1531 correspondingly. The bottom wall 12 defines a plurality of limiting slots 121 facing away from the top wall 11.

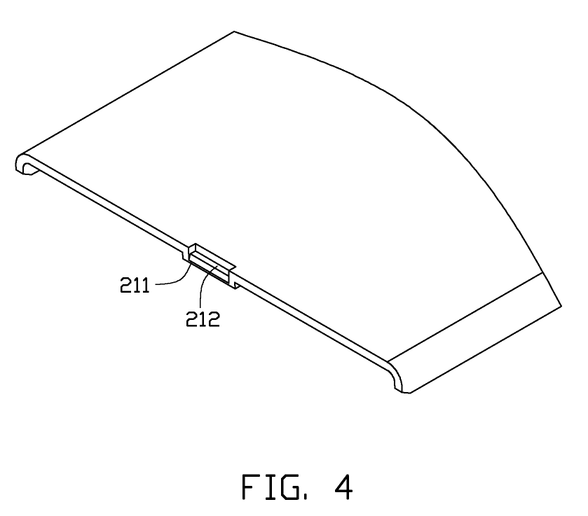

Referring to FIGS. 1 and 4, the battery cover 20 shields the battery receiving space 14. The battery cover 20 includes a first end 21 and an opposite second end 22. The first end 21 defines a latching slot 212, thus forming an ejection portion 211. The latching slot 212 is used to latch the battery cover 20 to the body member 10. The ejection portion 211 is used to resist the button member 30. The second end 22 includes a plurality of limiting blocks 221 protruding towards the first end 21. The limiting blocks 221 are insertable into the limiting slots 121.

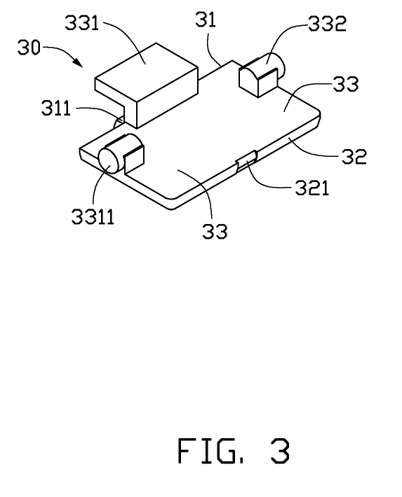

Referring to FIGS. 2 and 3 together, the button member 30 includes a first end wall 31, a second end wall 32 opposite to the first end wall 31, and a mounting surface 33. The first end wall 31 includes a latching block 311. The latching block 311 latches into the latching slot 212. The second end wall 32 includes a clamping portion 321, corresponding to the protrusion 1511. The clamping portion 321 latches with the protrusion 1511. An “L”-shaped resisting block 331 and two pivot shafts 332 protrude from the mounting surface 33. The resisting block 331 protrudes from the mounting surface 33 adjacent to the first end wall 31. The resisting block 331 is used to facilitate ejection of the battery cover 20. The two pivot shafts 332 are symmetrically secured to the mounting surface 33 between the resisting block 331 and the clamping portion 321. Each pivot shaft 332 partially protrudes out of the mounting surface 33 to form a free end 3321. The pivot shafts 332 are pivotably received in the pivot slots 1523, with the two free ends 3321 pivotably received in the pivot holes 1531 correspondingly.

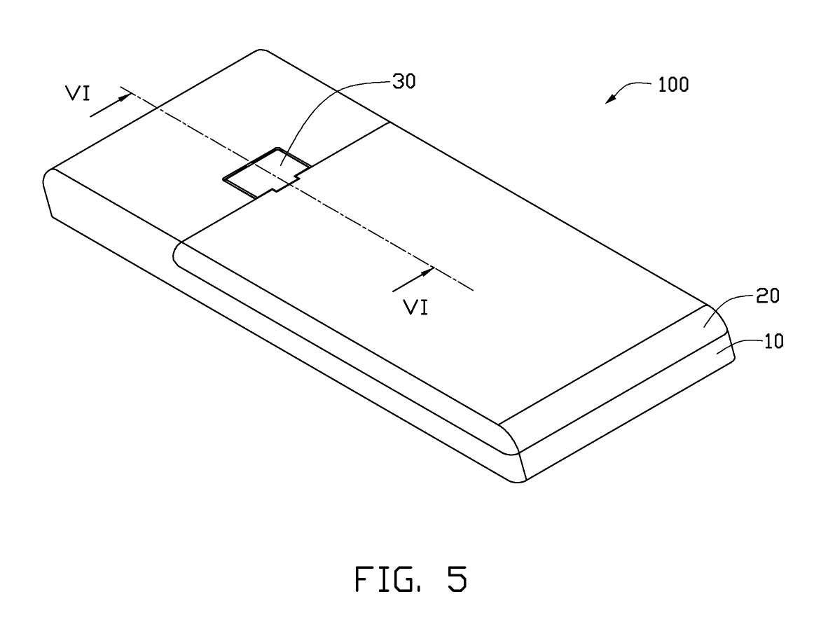

Referring to FIG. 5, to mount the button member 30 to the body member 10, the button member 30 is inserted into the cavity 15 of the body member 10. The resisting block 331 is received in the cutout 1522. Thus, the button member 30 can pivot about the pivot shafts 332 relative to the body member 10.

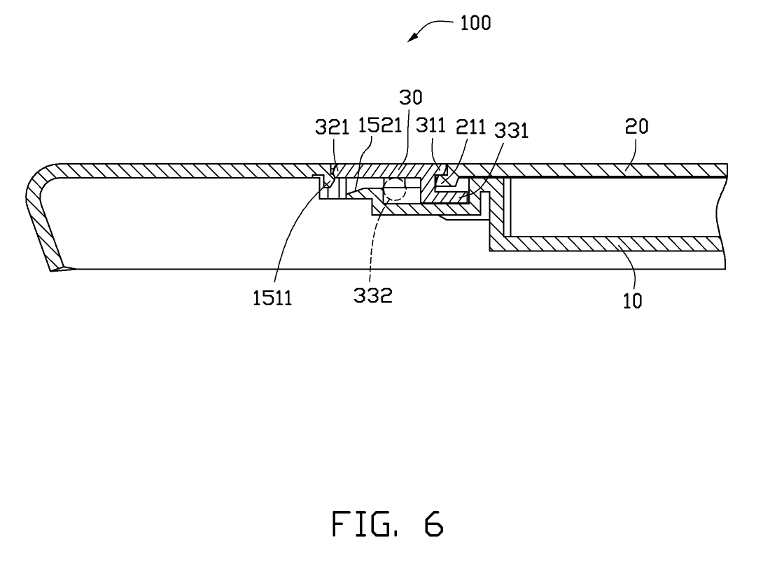

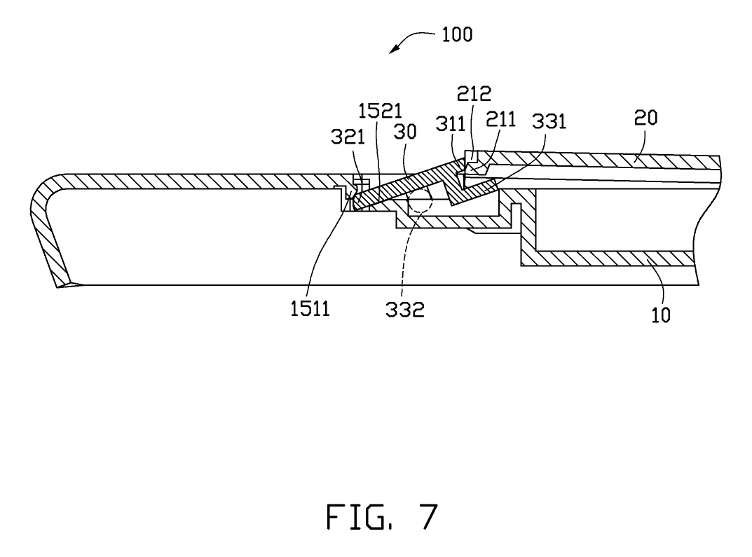

Referring to FIGS. 6 and 7, to mount the battery cover 20 to the body member 10, the battery cover 20 is generally placed over the battery receiving space 14, with the first end 21 facing the top wall 11 of the body member 10. The battery cover 20 is pushed towards the top wall 11 until the limiting blocks 221 latch into the limiting slots 121, with the latching block 311 and the resisting block 331 cooperatively latching/holding the ejection portion 211 between them. Then, the button member 30 is pivoted about the pivot shafts 332 to latch/insert the latching block 311 into the latching slot 212, thus the battery cover 20 is tightly latched to the body member 10.

To release the battery cover 20 from the body member 10, an external force is applied at the second end wall 32 of the button member 30 to pivot the button member 30 about the pivot shafts 332 counterclockwise until the clamping portion 321 moves beyond the protrusion 1511 and resists the resisting block 1521. At this time, the latching block 311 moves out of the latching slot 212 and the resisting block 331 resists the ejection portion 211 to eject the battery cover 20 away from the battery receiving space 14.

The battery cover latching mechanism 100 can tightly lock the battery cover 20 to the body member 10 using the button member 30, and also facilitate opening operation of the battery cover 20 with limited risk of damage.

It is to be understood, however, that even through numerous characteristics and advantages of the present disclosure have been set forth in the foregoing description, together with details of the structure and function of the disclosure, the disclosure is illustrative only, and changes may be made in detail, especially in matters of shape, size, and arrangement of sections within the principles of the disclosure to the full extent indicated by the broad general meaning of the terms, in which the appended claims are expressed.

What is claimed is:

1. A battery cover latching mechanism, comprising:
a body member defining a battery receiving space,
a battery cover being placed above the body member to cover the battery receiving space, the battery cover defining a latching slot; and
a button member including a latching block and a resisting block, the latching block latching in the latching slot, the resisting block configured for resisting the battery cover away from the body member.

2. The battery cover latching mechanism as claimed in claim 1, wherein the button member includes a first end wall, a second end wall opposite to the first end wall, and a mounting surface connecting the first end wall and the second end wall, the latching block protrudes from the first end wall, and the resisting block protrudes from the mounting surface adjacent to the first end wall.

3. The battery cover latching mechanism as claimed in claim 2, wherein the button member includes an ejection portion, the a resisting block resists the ejection portion to eject the battery cover away from the battery receiving space.

4. The battery cover latching mechanism as claimed in claim 1, wherein the button member includes a first end wall, a second end wall opposite to the first end wall, and a mounting surface connecting the first end wall and the second end wall, the second end wall includes a clamping portion, the body member includes a protrusion corresponding to the clamping portion, and the clamping portion latches with the protrusion.

5. The battery cover latching mechanism as claimed in claim 1, wherein the button member includes a first end wall, a second end wall opposite to the first end wall, and a mounting surface connecting the first end wall and the second end wall, two pivot shafts are symmetrically secured on the mounting surface, and the button member is pivotably mounted to the body member via the two pivot shafts.

6. The battery cover latching mechanism as claimed in claim 5, wherein each pivot shaft partially protrudes out of the mounting surface to form a free end, the body member includes two pivot slots and two pivot holes, the pivot slots and the pivot holes communicating with each other, and the pivot shafts are respectively received in the two pivot slots, with the two free ends respectively received in the pivot holes.

7. The battery cover latching mechanism as claimed in claim 1, wherein the battery cover includes limiting blocks, the body member includes limiting slots, and the limiting blocks latch in the limiting slots.

8. A battery cover latching mechanism, comprising:
a body member defining a battery receiving space;
a battery cover being placed above the body member to cover the battery receiving space; and
a button member pivotably mounted to the body member, the button member including a first end wall and a second end wall opposite to the first end wall, while the first end wall pivots towards the body member, the second end wall pivots away from the body member, so as to the battery cover from the body member.

9. The battery cover latching mechanism as claimed in claim 8, wherein a resisting block is formed adjacent to the second end wall, the resisting block configured for resisting the battery cover away from the body member.

10. The battery cover latching mechanism as claimed in claim 9, wherein the button member includes an ejection portion, the a resisting block resists the ejection portion to eject the battery cover away from the battery receiving space.

11. The battery cover latching mechanism as claimed in claim 10, wherein a latching block is formed adjacent to the first end wall, the battery cover defining a latching slot, the latching block latches in the latching slot.

12. The battery cover latching mechanism as claimed in claim 9, wherein the button member further includes a mounting surface connecting the first end wall and the second end wall, and the latching block protrudes from the first end wall, and the resisting block protrudes from the mounting surface adjacent to the first end wall.

13. The battery cover latching mechanism as claimed in claim 9, wherein the button member further includes a mounting surface connecting the first end wall and the second end wall, the second end wall includes a clamping portion, the body member includes a protrusion corresponding to the clamping portion, the clamping portion latches with the protrusion.

14. The battery cover latching mechanism as claimed in claim 9, wherein the button member further includes a mounting surface connecting the first end wall and the second end wall, and two pivot shafts are symmetrically secured to the mounting surface, the button member is pivotably mounted to the body member via the two pivot shafts.

15. The battery cover latching mechanism as claimed in claim 14, wherein each pivot shaft partially protrudes out of the mounting surface to form a free end, the body member includes two pivot slots and two pivot holes, the pivot slots and the pivot holes communicating with each other, the pivot shaft are respectively received in the two pivot slots, with the two free ends respectively received in the pivot holes.

16. The battery cover latching mechanism as claimed in claim 9, wherein the battery cover includes limiting blocks, the body member includes limiting slots, the limiting blocks latch in the limiting slots.
